(19) United States
(12) Patent Application Publication
(10) Pub. No.: US 2026/0189473 A1
(43) Pub. Date: Jul. 2, 2026

(54) COMMUNICATION METHOD AND APPARATUS, AND STORAGE MEDIUM

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 19/127,547

(22) PCT Filed: Nov. 6, 2022
(86) PCT No.: PCT/CN2022/130178

§ 371 Date: May 6, 2025

(51) Int. Cl. H04L 41/16; H04L 41/14

(52) U.S. Cl. CPC H04L 41/16; H04L 41/145

(57) ABSTRACT

The present disclosure relates to a communication method and apparatus, and a storage medium. The communication method is applied to a server, the server providing a node for an AI model, and the method comprising: sending an AI model to a wireless access network device, wherein the wireless access network device is a node for performing inference by using the AI model. Provided in the present disclosure is a feasible solution for providing an AI model for an AI inference node.

### CROSS-REFERENCE TO RELATED APPLICATION

The application is a U.S. National Stage of International Application No. PCT/CN2022/130178 filed on Nov. 6, 2022, the entire content of which is incorporated herein by reference.

### TECHNICAL FIELD

The present disclosure relates to the technical field of communication, and in particular to a communication method, apparatus and storage medium.

### BACKGROUND

In recent years, the artificial intelligence (AI) technology has made continuous breakthroughs in many fields. While integrating knowledge from different disciplines, AI has also provided new directions and methods for the development of different disciplines.

### SUMMARY

The present disclosure provides a communication method, apparatus and storage medium.

According to a first aspect of embodiments of the present disclosure, there is provided a communication method, including:
sending an AI model to a radio access network device; where the radio access network device is a node that performs inference using the AI model.

According to a second aspect of the embodiments of the present disclosure, there is provided a communication method, including:
receiving the AI model sent by a server; where the server is a provider node of the AI model.

According to a third aspect of the embodiments of the present disclosure, there is provided a communication method, including:
receiving an AI model sent by a server, where the server is a provider node of the AI model; and sending the AI model to a radio access network device; where the radio access network is a node that performs inference using the AI model.

According to a fourth aspect of the embodiments of the present disclosure, there is provided a communication method, including:
receiving an AI model sent by a server, where the server is a provider node of the AI model; send the AI model to a radio access network device; where the radio access network is a node that performs inference using the AI model.

According to a fifth aspect of the embodiments of the present disclosure, a communication apparatus is provided, including:
a sending unit, configured to send an AI model to a radio access network device; where the radio access network device is a node that performs inference using the AI model.

According to a sixth aspect of the embodiments of the present disclosure, a communication apparatus is provided, including:
a receiving unit, configured to receive an AI model sent by a server; where the server is a provider node of the AI model.

According to a seventh aspect of the embodiments of the present disclosure, a communication apparatus is provided, including:
a receiving unit, configured to receive an AI model sent by a server, where the server is a node providing the AI model; and a sending unit, configured to send the AI model to a radio access network device; where the radio access network is a node that performs inference using the AI model.

According to an eighth aspect of the embodiments of the present disclosure, a communication apparatus is provided, including:
a receiving unit, configured to receive an AI model sent by a server, where the server is a node providing the AI model; and a sending unit, configured to send the AI model to a radio access network device; where the radio access network is a node that performs inference using the AI model.

According to a ninth aspect of the embodiments of the present disclosure, a communication system is provided, including a server, a terminal, a radio access network device, and a core network device, where,
the server is configured to perform any one of the methods described in the first aspect;
the radio access network device is configured to perform any one of the methods described in the second aspect;
the terminal is configured to perform any one of the methods described in the third aspect; and the core network device is configured to perform any one of the methods described in the fourth aspect.

According to a tenth aspect of the embodiments of the present disclosure, a communication apparatus is provided, including:
a processor; and a memory for storing processor executable instructions; where the processor is configured to perform any one of the methods described in the first aspect.

According to an eleventh aspect of the embodiments of the present disclosure, there is provided a communication apparatus, including:
a processor; and a memory for storing processor executable instructions; where the processor is configured to perform any one of the methods described in the second aspect.

According to a twelfth aspect of the embodiments of the present disclosure, a communication apparatus is provided, including:
a processor; and a memory for storing processor executable instructions; where the processor is configured to perform any one of the methods described in the third aspect.

According to a thirteenth aspect of the embodiments of the present disclosure, a communication apparatus is provided, including:
a processor; and a memory for storing processor executable instructions; where the processor is configured to perform any one of the methods described in the fourth aspect.

According to a fourteenth aspect of the embodiments of the present disclosure, a storage medium is provided, in which instructions are stored. The instructions in the storage medium, when executed by a processor, cause the processor to execute any communication method described in the first aspect.

According to a fifteenth aspect of the embodiments of the present disclosure, a storage medium is provided, in which instructions are stored. The instructions in the storage medium, when executed by a processor, cause the processor to execute any communication method described in the second aspect.

According to a sixteenth aspect of the embodiments of the present disclosure, a storage medium is provided, in which instructions are stored. The instructions in the storage medium, when executed by a processor, cause the processor to execute any communication method described in the third aspect.

According to a seventeenth aspect of the embodiments of the present disclosure, a storage medium is provided, in which instructions are stored. The instructions in the storage medium, when executed by a processor, cause the processor to execute any communication method described in the fourth aspect.

It is to be understood that the foregoing general description and the following detailed description are merely exemplary and explanatory and should not be construed as limiting of the present disclosure.

### BRIEF DESCRIPTION OF THE DRAWINGS

The accompanying drawings, which are incorporated into the specification and constitute a part of the specification, illustrate embodiments that comply with the present disclosure, and are used together with the specification for explaining the principles of the present disclosure.

FIG. 1 is a schematic diagram of a communication system shown according to an exemplary embodiment.

FIG. 2 is a flow chart of a communication method shown according to an exemplary embodiment.

FIG. 3 is a flow chart of another communication method shown according to an exemplary embodiment.

FIG. 4 is a flow chart of yet another communication method shown according to an exemplary embodiment.

FIG. 5 is a flow chart of another communication method shown according to an exemplary embodiment.

FIG. 6 is a flow chart of yet another communication method shown according to an exemplary embodiment.

FIG. 7 is a flow chart of another communication method shown according to an exemplary embodiment.

FIG. 8 is a flow chart of a communication method shown according to an exemplary embodiment.

FIG. 9 is a flow chart of another communication method shown according to an exemplary embodiment.

FIG. 10 is a flow chart of yet another communication method shown according to an exemplary embodiment.

FIG. 11 is a flow chart of another communication method shown according to an exemplary embodiment.

FIG. 12 is a flowchart of yet another communication method shown according to an exemplary embodiment.

FIG. 13 is a flow chart of another communication method shown according to an exemplary embodiment.

FIG. 14 is a flow chart of yet another communication method shown according to an exemplary embodiment.

FIG. 15 is a flow chart of another communication method shown according to an exemplary embodiment.

FIG. 16 is a flow chart of yet another communication method shown according to an exemplary embodiment.

FIG. 17 is a flow chart of another communication method shown according to an exemplary embodiment.

FIG. 18 is a flow chart of yet another communication method shown according to an exemplary embodiment.

FIG. 19 is a flow chart of a communication method shown according to an exemplary embodiment.

FIG. 20 is a flow chart of another communication method shown according to an exemplary embodiment.

FIG. 21 is a flow chart of yet another communication method shown according to an exemplary embodiment.

FIG. 22 is a flow chart of another communication method shown according to an exemplary embodiment.

FIG. 23 is a schematic diagram of the transmission of an AI model among multiple devices shown according to an exemplary embodiment.

FIG. 24 is a schematic diagram of another transmission of an AI model among multiple devices shown according to an exemplary embodiment.

FIG. 25 is a schematic diagram of yet another transmission of an AI model among multiple devices shown according to an exemplary embodiment.

FIG. 26 is a schematic diagram of another transmission of an AI model among multiple devices shown according to an exemplary embodiment.

FIG. 27 is a block diagram of a communication apparatus shown according to an exemplary embodiment.

FIG. 28 is a block diagram of a communication apparatus shown according to an exemplary embodiment.

FIG. 29 is a block diagram of a communication apparatus shown according to an exemplary embodiment.

FIG. 30 is a block diagram of a communication apparatus shown according to an exemplary embodiment.

FIG. 31 is a block diagram of an apparatus for communication shown according to an exemplary embodiment.

FIG. 32 is a block diagram of an apparatus for communication shown according to an exemplary embodiment.

### DETAILED DESCRIPTION

Exemplary embodiments will now be described in detail herein, examples of which are illustrated in the drawings. The following description refers to the drawings in which the same numbers in different drawings represent the same or similar elements unless otherwise represented. The implementations set forth in the following description of the embodiments do not represent all implementations consistent with the present disclosure.

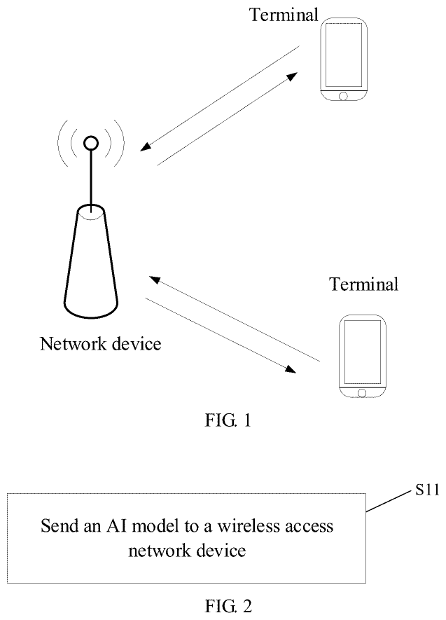

It can be understood that the wireless communication system shown in FIG. 1 is only schematically illustrated, and the wireless communication system may also include other network devices, such as a core network device, a wireless relay device, and a wireless backhaul device, etc., which are not shown in FIG. 1. Embodiments of the present disclosure do not limit the number of network devices and the number of terminals included in the wireless communication system.

It is further understood that the wireless communication system of the embodiments of the present disclosure is a network that provides wireless communication functions. The wireless communication system may employ different communication technologies, such as Code Division Multiple Access (CDMA), Wideband Code Division Multiple Access (WCDMA), Time Division Multiple Access (TDMA), Frequency Division Multiple Access (FDMA), Orthogonal Frequency-Division Multiple Access (OFDMA), Single Carrier FDMA (SC-FDMA), or Carrier Sense Multiple Access with Collision Avoidance. Depending on the capacity, rate, and delay of different networks, the networks can be classified as a second generation (2G) network, a 3G network, a 4G network, or a future evolved network such as a 5G network, which can also be called a New Radio (NR) network. For ease of description, the present disclosure will sometimes refer to the wireless communication network as simply network.

Further, the network device involved in the present disclosure may also be referred to as a radio access network device. The radio access network device may be: a base station, an evolved node B (base station), a home base station, an access point (AP) in a wireless fidelity (WiFi) system, a wireless relay node, a wireless backhaul node, a transmission point (TP), or a transmission and reception point (TRP), or a gNB in the NR system, or a component or part of devices constituting a base station, etc. It should be understood that in the embodiments of the present disclosure, the specific technology and the specific device form used for the network device are not limited. In addition, the network device may also be a vehicle-mounted device when the system is a Vehicle-to-Everything (V2X) communication system.

Further, the terminal involved in the present disclosure may also be referred to as a terminal device, a user equipment (UE), a mobile station (MS), a mobile terminal (MT), etc. The terminal is a device that provides voice and/or data connectivity to a user. For example, the terminal may be a handheld device with a wireless connection function, or a vehicle-mounted device, etc. Currently, some examples of the terminal are: a smart phone (Mobile Phone), a customer premise equipment (CPE), a pocket personal computer (PPC), a handheld computer, a personal digital assistant (PDA), a laptop computer, a tablet computer, a wearable device, or a vehicle-mounted device, etc. In addition, when the system is a vehicle-to-everything (V2X) communication system, the terminal device may also be a vehicle-mounted device. It should be understood that the embodiments of the present disclosure do not limit the specific technology and specific device form adopted by the terminal.

At present, in the related art, in the research on wireless AI technology, application cases of AI may include, for example: AI-based channel state information (CSI) enhancement, AI-based beam association, AI-based positioning, etc.

In the related art, there are multiple types of communication devices such as servers, core network devices, radio access network devices, and terminals in the communication system. The communication system supports communication between different communication devices based on the AI model. However, the communication based on the AI model includes a provider node of the AI model and an inference node of the AI model. When the provider node of the AI model and the inference node of the AI model are located on different communication devices, there is a transmission demand for transmitting the AI model from one communication device to another communication device.

There are two very important stages involved in AI operations. For example, the first stage may be the training stage of the AI model, that is, the stage of obtaining the AI model. The second stage may be the deployment stage of the AI model, that is, the inference application stage of the AI model. For the deployment stage, it is necessary to pre-configure the provider node and the inference node among the communication devices. The provider node refers to a node that provides the trained AI model, and the inference node refers to a node that performs the inference task based on the AI model. Since the same communication system often involves multiple communication devices, and the communication among communication devices based on the AI model often involves multiple processing nodes. Therefore, for multiple communication devices involved in the communication system, there are various manners to configure the processing nodes. For example, the provider node and the inference node may be configured on the same communication device. Alternatively, the provider node and the inference node may be configured on different communication devices.

For a scenario where the provider node and the inference node are located on different communication devices, the communication device carrying the inference node needs to be provided with the AI model by the communication device carrying the provider node. Therefore, in the related art, there is a transmission demand for transmitting the AI model from one communication device to another communication device. However, how to transmit the AI model between different communication devices, a reasonable and effective implementation plan has not yet been proposed in the related art.

In view of this, the present disclosure provides a communication method, which is intended to send an AI model from an AI provider node to an AI inference node in a scenario where the AI inference node and the AI provider node are located on different devices. For example, when the AI provider node is located on a server and the AI inference node is located on a radio access network device, the server transmits the AI model to the radio access network device so that the radio access network device performs an inference task according to the received AI model.

FIG. 2 is a flow chart of a communication method shown according to an exemplary embodiment. As shown in FIG. 2, the method is applied to a server, where the server is a provider node of an AI model, and the method includes the following steps.

In step S11, an AI model is sent to a radio access network device.

In the embodiment of the present disclosure, the radio access network is a node that uses an AI model for performing inference. The server sends the AI model to the radio access network device so that the radio access network device carrying the AI inference node can smoothly perform an inference task based on the AI model.

For example, as a feasible implementation, the AI model required by the AI inference node may be determined by the server.

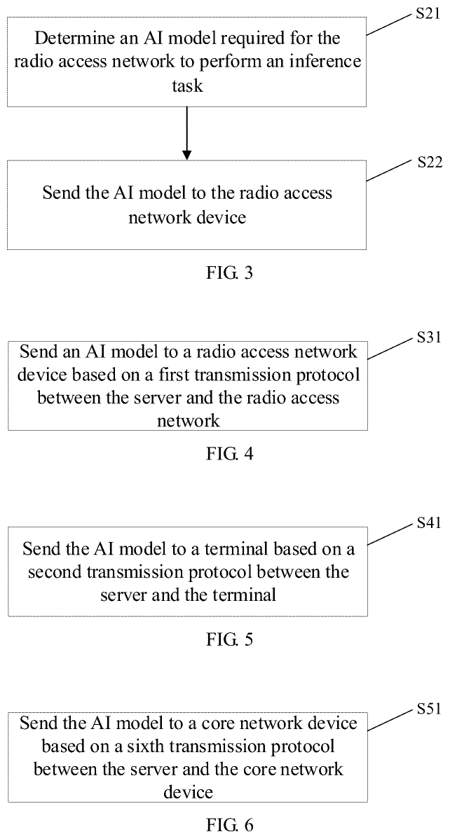

FIG. 3 is a flow chart of another communication method shown according to an exemplary embodiment. As shown in FIG. 3, the method includes the following steps.

In step S21, an AI model required by the radio access network to perform an inference task is determined.

In step S22, the AI model is sent to the radio access network device.

In one implementation, the server may directly send the AI model to the radio access network device via a transmission protocol between the server and the terminal.

For example, when the server sends the AI model to a radio access network device, the transmission protocol used may be understood as a transmission protocol specifically configured by the server for communicating with the radio access network.

For the convenience of description in the present disclosure, the transmission protocol used for the communication between the server and the radio access network is referred to as a first transmission protocol.

FIG. 4 is a flow chart of yet another communication method shown according to an exemplary embodiment, as shown in FIG5, which is applied to a server, where the server is a provider node of an AI model, and the method includes the following steps.

In step S31, an AI model is sent to a radio access network device based on a first transmission protocol between the server and the radio access network.

In the embodiment of the present disclosure, the first transmission protocol between the server and the radio access network may be a transmission protocol supporting data transmission, or may be a transmission protocol supporting signaling transmission.

In addition, it should be noted that, in addition to the first transmission protocol, the following embodiments of the present disclosure further involve a second transmission protocol, a third transmission protocol, a fourth transmission protocol, a fifth transmission protocol, a sixth transmission protocol, and a seventh transmission protocol. These transmission protocols are respectively used to support the AI model transmission between different communication devices. Those transmission protocols are similar to the first transmission protocol and may be configured as the transmission protocol supporting the data transmission, or the transmission protocol supporting the signaling transmission.

In the embodiments of the present disclosure, in addition to the above method of directly transmitting the AI model to the radio access network device through the server, the present disclosure may also use the terminal as an intermediate node to realize the indirect transmission of the AI model. For example, the indirect transmission of the AI model may be performed in the following manner.

For the convenience of description in the present disclosure, the transmission protocol used for the communication between the server and the terminal is referred to as a second transmission protocol.

FIG. 5 is a flow chart of another communication method shown according to an exemplary embodiment. As shown in FIG. 5, the method includes the following steps.

In step S41, the AI model is sent to the terminal based on the second transmission protocol between the server and the terminal.

The method provided by the embodiment of the present disclosure may further send the received AI model to the radio access network device based on the terminal receiving the AI model, so that the AI model stored in server is transmitted to the radio access network device.

The terminal sends the received AI model to the radio access network device, for example, it may be sent to the radio access network device through a transmission protocol between the terminal and the radio access network device. For ease of description, the transmission protocol between the terminal and the radio access network device is referred to as a third transmission protocol.

In the embodiment of the present disclosure, the third transmission protocol may be, for example, an air interface protocol between the terminal and the radio access network device, and through which signaling is sent to the radio access network device. In addition, as a feasible implementation, the terminal may encapsulate the AI model through the air interface protocol and send the encapsulated AI model to the radio access network device.

For example, the air interface protocol signaling includes at least one of a physical layer signaling, a logical access layer (Medium Access Control, MAC) signaling, a radio resource control (RRC) signaling, and an air interface user plane signaling.

For example, the server may send the AI model to the terminal in an encapsulated form. For example, the server encapsulates the AI model based on the second transmission protocol and sends it to the terminal.

In the embodiment in the present disclosure, in addition to the above method of using the terminal alone as an intermediate node to forward the AI model to the radio access network device, for example, the terminal and the core network device may also be jointly used as intermediate nodes. In this scenario, the server sends the AI model, which is finally sent to the radio access network device after passing through the terminal and the core network device. Correspondingly, for the server, when sending the AI model to the terminal, the AI model may be sent by the terminal to the core network device, and then sent by the core network device to the radio access network device.

For example, the AI model is sent by the terminal to the core network device. For example, the AI model is sent by the terminal to the core network device based on the transmission protocol between the terminal and the core network device. For the convenience of description below, the transmission protocol between the terminal and the core network device is referred to as a fourth transmission protocol.

As a feasible implementation mode, the AI model may be encapsulated and sent to the core network device by the terminal based on the fourth transmission protocol.

Accordingly, as a feasible implementation manner, the AI model is sent by the core network device to the radio access network device. For example, the AI model may be sent by the core network device to the radio access network device based on a transmission protocol between the core network device and the radio access network device. For the convenience of description below, the transmission protocol between the core network device and the radio access network device is referred to as a fifth transmission protocol.

For example, the core network device may send the AI model to the radio access network device through a transmission protocol between an AMF and the radio access network device. For another example, the core network device may send the AI model to the radio access network device through a transmission protocol between a UPF and the radio access network device.

In the embodiment of the present disclosure, the server may send the AI model to the core network device through a transmission protocol between the server and the core network. For the convenience of description below, the transmission protocol between the server and the core network is referred to as a sixth transmission protocol.

FIG. 6 is a flow chart of yet another communication method shown according to an exemplary embodiment. As shown in FIG. 6, the method includes the following steps.

In step S51, the AI model is sent to a core network device based on a sixth transmission protocol between the server and the core network device.

According to the method provided in the embodiment of the present disclosure, the server can realize the transmission of the AI model through the sixth transmission protocol used for communicating with the core network device.

For example, as a feasible implementation, when the server sends the AI model to the core network device, the AI model may also be sent in an encapsulated form. For example, the server encapsulates the AI model and sends it to the core network device based on the sixth transmission protocol.

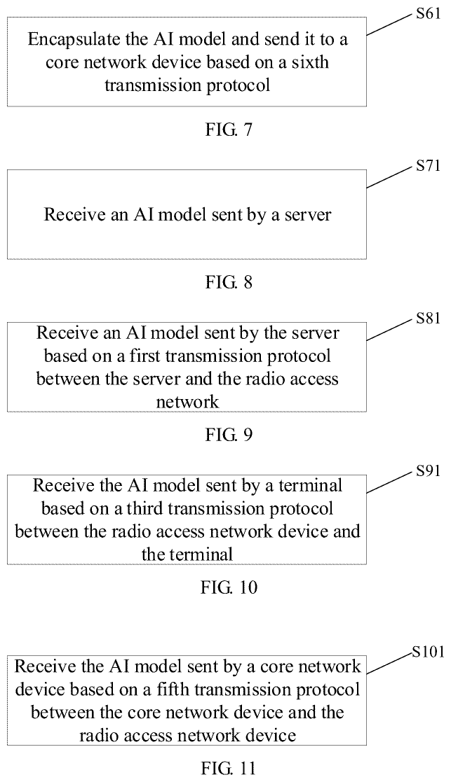

FIG. 7 is a flow chart of another communication method according to an exemplary embodiment. As shown in FIG. 7, the method includes the following steps.

In step S61, the AI model is encapsulated and sent to the core network device based on the sixth transmission protocol.

In the embodiment of the present disclosure, the AI model is sent by the core network device to the radio access network device, for example, the AI model is sent by the core network device to the radio access network device based on the fifth transmission protocol. In addition, before sending the AI model, the core network device may encapsulate the AI model through the fifth transmission protocol.

The methods provided by the embodiments of the present disclosure provide a variety of flexible manners for the radio access network to acquire the AI model, for a scenario where a server carries an AI provider node, a radio access network device carries an AI inference node, and the communication system includes a server, a core network device, a terminal, and a radio access network device.

Based on the same concept, the present disclosure provides another communication method, which is applied to a radio access network device carrying an AI inference node, and is used to interact with the server involved in any of the above embodiments to complete the transmission of the AI model. If there are any unclear points in the following embodiments, reference may be made to any of the above embodiments. Similarly, if there are any unclear points in the above embodiments, reference may be made to any of the following embodiments.

FIG. 8 is a flow chart of a communication method shown according to an exemplary embodiment. As shown in FIG. 8, the communication method is applied to a radio access network device, where the radio access network device is a node for performing inference by an AI model, and includes the following steps.

In step S71, an AI model sent by the server is received.

In the embodiment in the present disclosure, the server is a provider node of the AI model, and the radio access network device may receive the AI model and perform inference tasks based on the AI model.

As a feasible implementation, the radio access network device may receive the AI model through a transmission protocol between the radio access network device and the server.

FIG. 9 is a flow chart showing another communication method shown according to an exemplary embodiment. As shown in FIG. 9, the method includes the following steps.

In step S81, an AI model sent by the server is received based on a first transmission protocol between the server and the radio access network.

In the embodiments of the present disclosure, in addition to the above-mentioned method of directly transmitting the AI model to the radio access network device through the server, the present disclosure may also use the terminal as an intermediate node to realize the indirect transmission of the AI model. For example, the indirect transmission of the AI model may be performed in the following manner.

FIG. 10 is a flow chart of yet another communication method shown according to an exemplary embodiment. As shown in FIG. 10, the method includes the following steps.

In step S91, an AI model sent by the terminal is received based on a third transmission protocol between the radio access network device and the terminal.

In the method provided by the embodiment of the present disclosure, the AI model may be sent by the server to the terminal, and then forwarded to the radio access network device via the terminal. The AI model is sent by the server to the terminal, for example, the server may send it to the terminal based on the second transmission protocol between the server and the terminal.

In the embodiment in the present disclosure, in addition to the above method of using the terminal alone as an intermediate node to forward the AI model to the radio access network device, for example, the terminal and the core network device may also be jointly used as intermediate nodes. In this scenario, the server sends the AI model, which is finally sent to the radio access network device after passing through the terminal and the core network device.

FIG. 11 is a flow chart of another communication method shown according to an exemplary embodiment. As shown in FIG. 11, the method includes the following steps.

In step S101, an AI model sent by a core network device based on a fifth transmission protocol between the core network device and the radio access network device is received.

In the method provided by the embodiments of the present disclosure, the AI model may be sent by the server to the terminal, and then sent by the terminal to the core network device. Accordingly, the radio access network device may receive the AI model sent by the core network device to complete the transmission process of the AI model. Accordingly, the radio access network carrying the AI inference node can perform the inference task through the received AI model.

The AI model is sent to the core network device by the terminal, for example, the AI model is sent to the core network device by the terminal based on a fourth transmission protocol between the terminal and the core network device. The AI model is sent to the terminal by the server, for example, the AI model is sent to the terminal by the server based on a second transmission protocol between the server and the terminal.

Of course, the core network device may also serve as a single intermediate node. For example, the AI model is sent to the core network device by the server based on a sixth transmission protocol between the server and the core network device. Furthermore, the radio access point receives the AI model sent by the core network device based on a seventh transmission protocol between the core network device and the radio access network device.

In the above embodiments, the AI model received by the radio access network may be, for example, an AI model encapsulated and sent based on a transmission protocol. The transmission protocol used to encapsulate the AI model may be, for example, the first transmission protocol, the third transmission protocol, the fifth transmission protocol, or the seventh transmission protocol involved above. In this regard, in the embodiments of the present disclosure, the radio access point may parse the encapsulated AI model based on the transmission protocol used to receive the AI model. For example, if the radio access point receives the AI model through the first transmission protocol, the AI model may be further parsed through the first transmission protocol.

Based on the same concept, the present disclosure provides another communication method, which is applied to a terminal and is used to interact with the server, the radio access network device, and/or the terminal involved in any of the above embodiments to complete the forwarding of the AI model. If there is anything unclear in the following embodiments, reference may be made to any of the above embodiments. Similarly, if there is anything unclear in the above embodiments, reference may be made to any of the following embodiments.

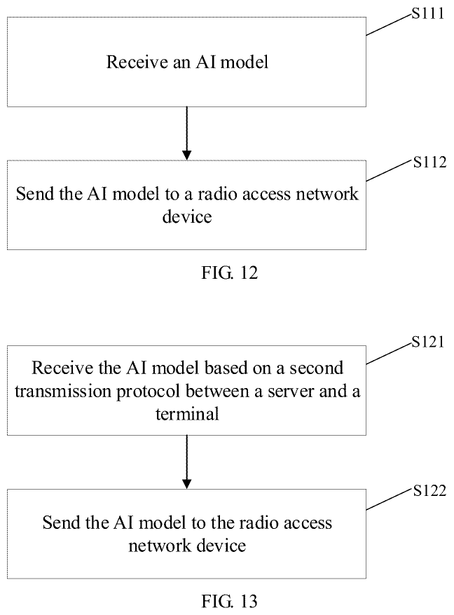

FIG. 12 is a flow chart of yet another communication method shown according to an exemplary embodiment. As shown in FIG. 12, the communication method is applied to a terminal and includes the following steps.

In step S111, an AI model is received.

In step S112, the AI model is sent to a radio access network device.

In the embodiment in the present disclosure, the AI model is sent by a server, and the server is a provider node of the AI model. When the terminal receives the AI model, the terminal sends the AI model to a radio access network device, so that the radio access network device carrying the AI inference node can receive the AI model.

As a feasible manner, the terminal may receive the AI model via a second transmission protocol between the terminal and the server.

FIG. 13 is a flow chart of another communication method shown according to an exemplary embodiment. As shown in FIG. 13, the method includes the following steps.

In step S121, an AI model is received based on a second transmission protocol between the server and the terminal.

In step S122, the AI model is sent to the radio access network device.

For example, the server may encapsulate the AI model through the second transmission protocol and send it to the terminal. Correspondingly, the terminal may parse the encapsulated AI model through the second transmission protocol to obtain the AI model to be sent to the radio access network device.

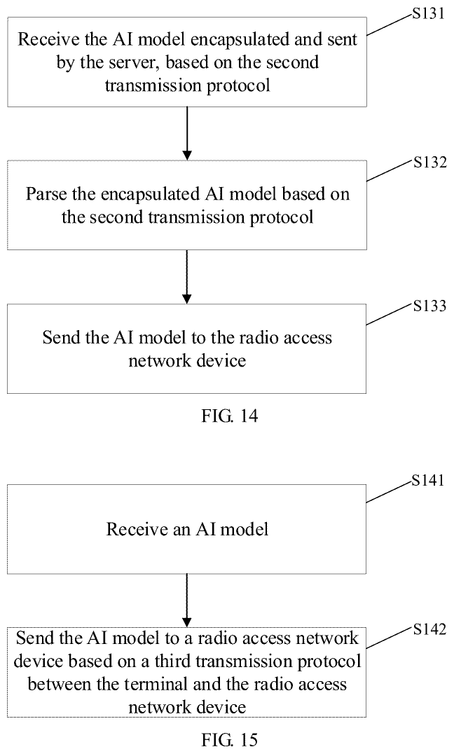

FIG. 14 is a flow chart of yet another communication method shown according to an exemplary embodiment, which, as shown in FIG. 14, includes the following steps.

In step S131, the AI model encapsulated and sent by the server is received based on the second transmission protocol.

In step S132, the encapsulated AI model is parsed based on the second transmission protocol.

In step S133, the AI model is sent to the radio access network device.

In the embodiment in the present disclosure, the terminal may serve as an intermediate node for transmitting the AI model between the server and the radio access network device. When the server sends the AI model to the terminal, the terminal may transmit the AI model through the transmission protocol between the terminal and the radio access network device. Exemplarily, the terminal sends the AI model to the radio access network device, for example, through the third transmission protocol used for communication between the terminal and the radio access network.

FIG. 15 is a flow chart of another communication method shown according to an exemplary embodiment. As shown in FIG. 15, the method includes the following steps.

In step S141, an AI model is received.

In step S142, the AI model is sent to the radio access network device based on a third transmission protocol between the terminal and the radio access network device.

Furthermore, the terminal may also encapsulate the AI model through the third transmission protocol to send the encapsulated AI model to the radio access network device.

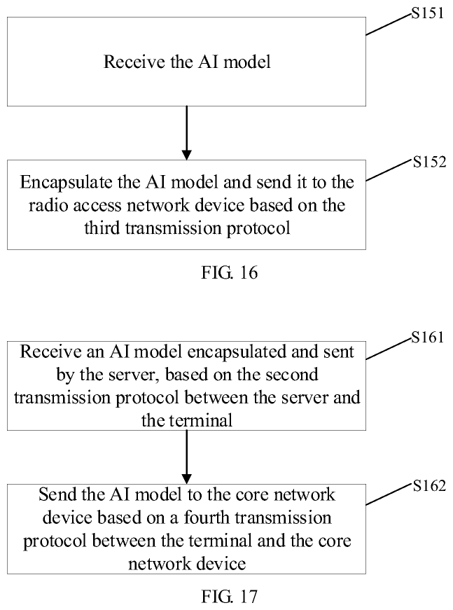

FIG. 16 is a flow chart of yet another communication method shown according to an exemplary embodiment. As shown in FIG. 16, the method includes the following steps.

In step S151, an AI model is received.

In step S152, the AI model is encapsulated and sent to the radio access network device based on the third transmission protocol.

In the embodiment of the present disclosure, the third transmission protocol may be, for example, an air interface protocol. Accordingly, the AI model being encapsulated and sent to the core network device may be implemented, for example, by the terminal carrying the AI model through air interface protocol signaling, and then sending the air interface protocol signaling. The air interface protocol signaling may include, for example, at least one of physical layer signaling, MAC signaling, RRC signaling, and air interface user plane signaling.

In the embodiments of the present disclosure, in addition to the above-mentioned method of using the terminal alone as an intermediate node to forward the AI model to the radio access network device, for example, the terminal and the core network device may also be jointly used as intermediate nodes. In this scenario, the server sends the AI model, which is finally sent to the radio access network device after passing through the terminal and the core network device.

FIG. 17 is a flow chart of another communication method shown according to an exemplary embodiment. As shown in FIG. 17, the method includes the following steps.

In step S161, an AI model encapsulated and sent by the server is received based on the second transmission protocol between the server and the terminal.

In step S162, the AI model is sent to the core network device based on a fourth transmission protocol between the terminal and the core network device.

In the embodiment in the present disclosure, the AI model is sent by the server, forwarded by the terminal and the core network device, and finally received by the radio access network device. The terminal forwarding the AI model to the core network device may be implemented, for example, through the fourth transmission protocol.

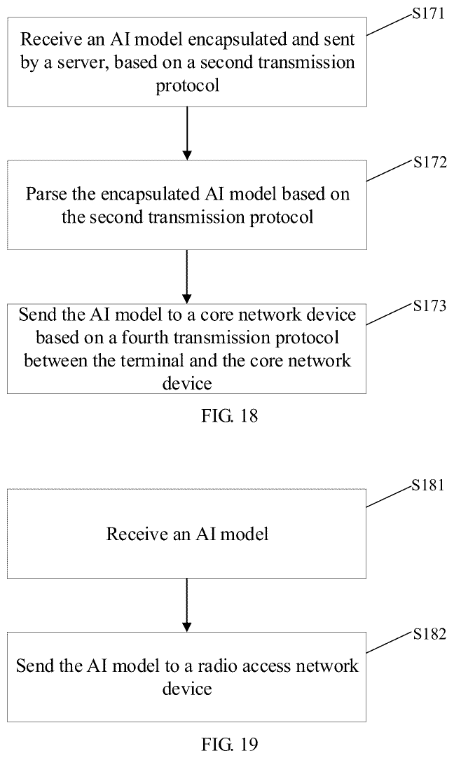

FIG. 18 is a flow chart of yet another communication method shown according to an exemplary embodiment. As shown in FIG. 18, the method includes the following steps.

In step S171, an AI model encapsulated and sent by the server is received based on the second transmission protocol;

In step S172, the encapsulated AI model is parsed based on the second transmission protocol.

In step S173, the AI model is sent to the core network device based on a fourth transmission protocol between the terminal and the core network device.

In the method provided by the embodiment of the present disclosure, the server sends the AI model to the terminal, so that the terminal further sends the AI model to the core network device. On this basis, the AI model may be sent by the core network device to the radio access network device to complete the transmission of the AI model. The fourth transmission protocol may include, for example, a non-access stratum (NAS) signaling protocol and/or a user plane (UP) protocol.

Based on the same concept, the present disclosure provides another communication method, which is applied to a core network device and is used to interact with the server, the radio access network device and/or the terminal involved in any of the above embodiments to complete the forwarding of the AI model. If there are any unclear points in the following embodiments, reference may be made to any of the above embodiments. Similarly, if there are any unclear points in the above embodiments, reference may be made to any of the following embodiments.

FIG. 19 is a flow chart of a communication method shown according to an exemplary embodiment. As shown in FIG. 19, the communication method is applied to a core network device and includes the following steps.

In step S181, an AI model is received.

In step S182, the AI model is sent to a radio access network device.

In the embodiment in the present disclosure, the AI model is sent by a server, and the server is a provider node of the AI model. When the terminal receives the AI model, the terminal sends the AI model to the radio access network device, so that the radio access network device carrying the AI inference node can implement reception of the AI model.

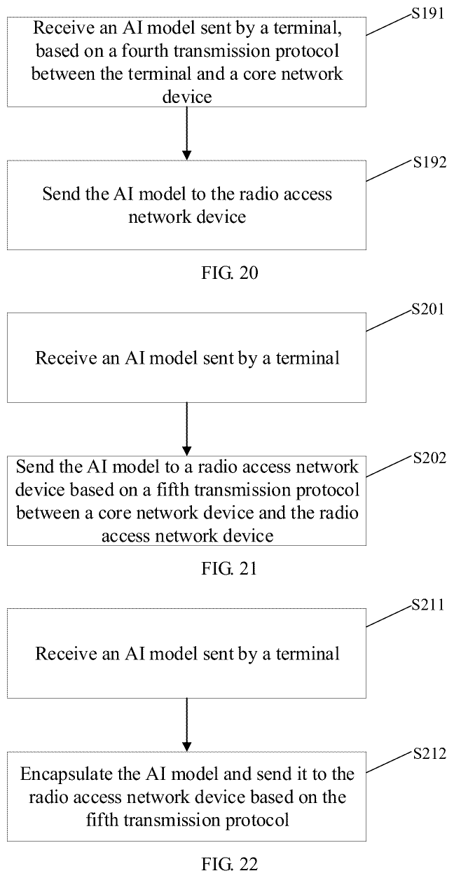

FIG. 20 is a flow chart of another communication method shown according to an exemplary embodiment. As shown in FIG. 20, the communication method is applied to a core network device and includes the following steps.

In step S191, an AI model sent by the terminal is received based on a fourth transmission protocol between the terminal and the core network device.

In step S192, the AI model is sent to the radio access network device.

In the embodiment in the present disclosure, the terminal sends the AI model to the core network device, so that the core network device sends the AI model to the radio access network device.

FIG. 21 is a flow chart of yet another communication method shown according to an exemplary embodiment. As shown in FIG. 21, the communication method is applied to a core network device and includes the following steps.

In step S201, an AI model sent by a terminal is received.

In step S202, the AI model is sent to a radio access network device based on a fifth transmission protocol between the core network device and the radio access network device.

For example, the core network device may encapsulate the AI model through the fifth transmission protocol to transmit the encapsulated AI model to the radio access network device.

FIG. 22 is a flow chart of another communication method shown according to an exemplary embodiment. As shown in FIG. 22, the communication method is applied to a core network device and includes the following steps.

In step S211, an AI model sent by the terminal is received.

In step S212, the AI model is encapsulated and sent to the radio access network device based on the fifth transmission protocol.

For example, the fifth transmission protocol may be a transmission protocol between an AMF and the radio access network device, or a transmission protocol between a UPF and the radio access network device.

In the embodiment in the present disclosure, the provider node of the AI model is located on the server, and the inference node of the AI model is located on the radio access network device. In other words, the AI model required for the radio access network device to perform the inference task is currently stored by the server. In this scenario, the AI model can be sent by the server and received by the radio access network device.

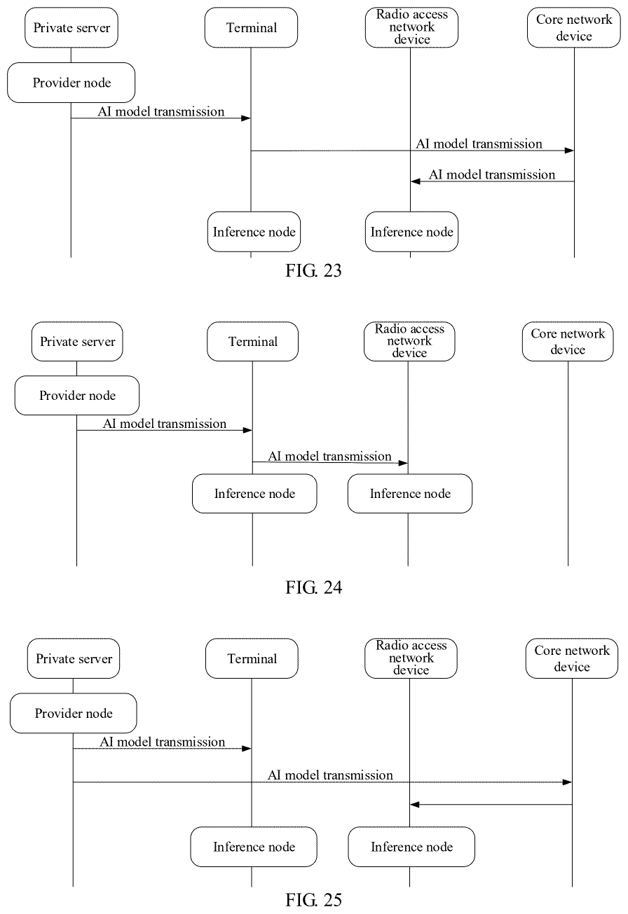

In one example, as shown in FIG. 23, the AI model may be transmitted from the server to the terminal through a transmission protocol between the server and the terminal. On this basis, the terminal may send the AI model to the core network device through a communication interface (e.g., the NAS signaling interface or the UP protocol interface) between the core network device and the terminal. Furthermore, the core network device may transmit the AI model to the radio access network device through a communication interface between the core network device and the radio access network device, so that the radio access network device can obtain the AI model required to perform the inference task. Taking NWDAF as an example, the NWDAF may transmit the AI model to the radio access network device through a dedicated interface between the radio access network device and the NWDAF. Alternatively, the NWDAF first sends the AI model to OAM, and then the OAM sends the AI model to the radio access network device.

Of course, some of the above processes may also be directly applied to AI model transmission when the inference node is located on the terminal or core network device. For example, the terminal or core network device may receive the AI model through the above process and perform the inference task through the received AI model.

In another example, as shown in FIG. 24, the server may encapsulate the AI model and transmit the AI model to the terminal through a transmission protocol between the server and the terminal. On this basis, the terminal may re-encapsulate the AI model to send the re-encapsulated AI model to the radio access network device through an air interface protocol signaling. The air interface protocol signaling includes but is not limited to a physical layer signaling, an MAC signaling, an RRC signaling or an air interface user plane signaling.

In another example, as shown in FIG. 25, the server may directly transmit the AI model to the radio access network device through a dedicated communication interface between the server and the radio access network device. The radio access network device may receive the AI model and perform inference tasks based on the AI model.

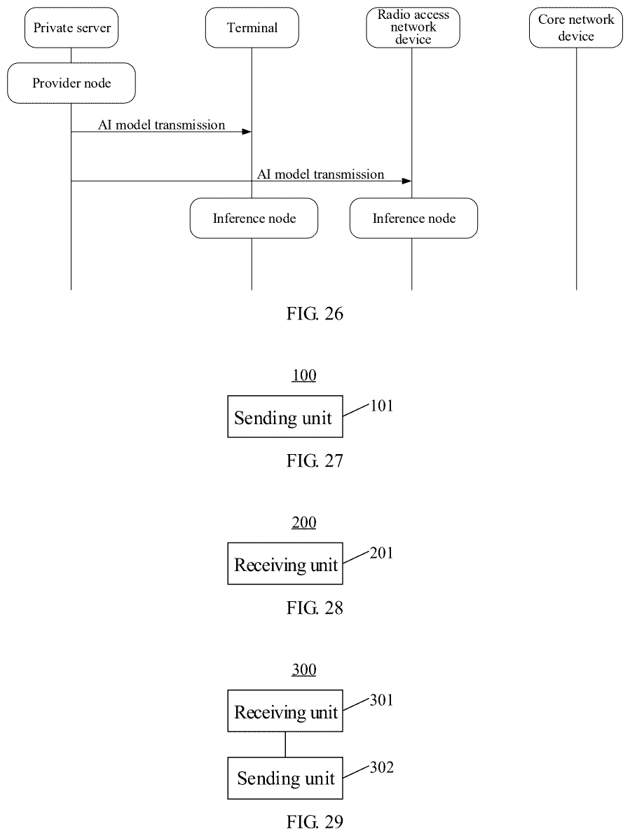

In another example, as shown in FIG. 26, the server sends the AI model to the core network device through a dedicated communication interface between the server and the core network device, and the core network device re-encapsulate the AI model to send the re-encapsulated AI model to the radio access network device. Taking the core network device as NWDAF as an example, the core network device sends the AI model to the radio access network device. For example, NWDAF transmits the AI model to the radio access network device through a dedicated communication interface between the server and the radio access network device. For another example, NWDAF may first send the AI model to OAM, and then OAM may send the AI model to the radio access network device.

In the embodiments of the present disclosure, a complete AI model or a partial AI model may be transmitted between the server and the radio access network device. The partial AI model may be understood as the remaining part of the AI model after discarding at least one of one or more network layers, one or more computing elements, one or more connection relationships, and one or more configuration weights. For example, only part of the network layers of the AI model, or part of the computing elements, or only the weights connecting the elements may be transmitted.

In addition, it should be noted that for the scenario in which the core network device and the terminal communicate based on the AI model, the current demand is that the core network device provide the AI model required for the terminal to perform the inference task. However, in actual scenarios, the terminal may also provide the AI model required for the core network device to perform the inference task, that is, the provider node of the AI model is located on the terminal, and the inference node of the AI model is located on the core network device. For this scenario, the provisions of the present disclosure on the transmission of the AI model are also applicable. For example, the terminal may send the AI model to the core network device through a fourth transmission protocol between the terminal and the core network device. For another example, the terminal sends the AI model to the radio access network device through a third transmission protocol, and the radio access network device sends the AI model to the core network device through a communication interface between the terminal and the core network device.

It should be noted that those skilled in the art can understand that the various implementations/embodiments involved in the embodiments of the present disclosure can be used in conjunction with the aforementioned embodiments or can be used independently. Whether used alone or in conjunction with the aforementioned embodiments, the implementation principle is similar. In the implementation of the present disclosure, some embodiments are described in terms of implementations used together. Of course, those skilled in the art can understand that such examples are not limitations of the embodiments of the present disclosure.

Based on the same concept, the embodiments of the present disclosure further provide a communication apparatus.

It is understandable that the communication apparatus provided by the embodiment of the present disclosure includes a hardware structure and/or software module corresponding to each function in order to realize the above functions. With reference to the units and algorithm steps of each example disclosed in the embodiment of the present disclosure, the embodiment of the present disclosure can be implemented in the form of hardware or a combination of hardware and computer software. Whether a function is executed in the form of hardware or computer software driving hardware depends on the specific application and design constraints of the technical solution. Those skilled in the art can use different methods to implement the described functions for each specific application, but such implementation should not be considered to exceed the scope of the technical solution of the embodiment of the present disclosure.

FIG. 27 is a block diagram of a communication apparatus shown according to an exemplary embodiment. Referring to FIG. 27, the apparatus 100 includes a sending unit 101.

The sending unit 101 is used to send an AI model to a radio access network device; and the radio access network device is a node that performs inference using the AI model.

In one implementation, the sending unit 101 sends the AI model to the radio access network device in the following manner: sending the AI model to the radio access network device based on a first transmission protocol between a server and the radio access network.

In one implementation, the sending unit 101 sends the AI model to the radio access network device in the following manner: sending the AI model to a terminal based on a second transmission protocol between the server and the terminal; where the AI model is sent by the terminal to the radio access network device based on a third transmission protocol between the terminal and the radio access network device.

In one implementation, the sending unit 101 sends the AI model to the terminal based on the second transmission protocol between the server and the terminal in the following manner: encapsulating the AI model and sending it to the terminal based on the second transmission protocol.

In one implementation, the sending unit 101 uses the following manner to send the AI model from the terminal to the radio access network device: the AI model being sent from the terminal to a core network device based on a fourth transmission protocol between the terminal and the core network device; where the AI model is sent by the core network device to the radio access network device based on a fifth transmission protocol between the core network device and the radio access network device.

In one implementation, the AI model being sent by the terminal to the core network device based on the fourth transmission protocol between the terminal and the core network device, includes: the AI model being encapsulated and sent by the terminal to the core network device based on the fourth transmission protocol.

In one implementation, the sending unit 101 sends the AI model to the radio access network device in the following manner: sending the AI model to a core network device based on a sixth transmission protocol between the server and the core network device; where the AI model is sent by the core network device to the radio access network device based on a seventh transmission protocol between the core network device and the radio access network device.

In one implementation, the sending unit 101 sends the AI model to the core network device based on the sixth transmission protocol between the server and the core network device in the following manner: encapsulating the AI model and sending it to the core network device based on the sixth transmission protocol.

FIG. 28 is a block diagram of a communication apparatus shown according to an exemplary embodiment. Referring to FIG. 28, the apparatus 200 includes a receiving unit 201.

The receiving unit 201 is configured to receive an AI model sent by a server; and the server is a provider node of the AI model.

In one implementation, the receiving unit 201 receives the AI model sent by the server in the following manner: receiving the AI model sent by the server based on a first transmission protocol between the server and the radio access network.

In one implementation, the receiving unit 201 receives the AI model sent by the server in the following manner: receiving the AI model sent by the terminal based on a third transmission protocol between the radio access network device and the terminal; where the AI model is sent by the server to the terminal based on a second transmission protocol between the server and the terminal.

In one implementation, the receiving unit 201 receives the AI model sent by a terminal in the following manner: receiving the AI model sent by a core network device based on a fifth transmission protocol between the core network device and the radio access network device; where the AI model is sent by the terminal to the core network device based on a fourth transmission protocol between the terminal and the core network device; and the AI model is sent by the server to the terminal based on a second transmission protocol between the server and the terminal.

In one implementation, the receiving unit 201 receives the AI model sent by the server in the following manner: receiving the AI model sent by a core network device based on a seventh transmission protocol between the core network device and the radio access network device; where the AI model is sent to the core network device by the server based on a sixth transmission protocol between the server and the core network device.

In one implementation, the received AI model includes an AI model encapsulated and sent based on a transmission protocol, and the transmission protocol includes the first transmission protocol, the third transmission protocol, the fifth transmission protocol or the seventh transmission protocol; and the receiving unit 201 is further configured to: parse the encapsulated AI model based on the transmission protocol used to receive the AI model.

FIG. 29 is a block diagram of a communication apparatus shown according to an exemplary embodiment. Referring to FIG. 29, the apparatus 300 includes a receiving unit 301 and a sending unit 302.

The receiving unit 301 is configured to receive an AI model, where the AI model is sent by a server, and the server is a node providing the AI model. The sending unit 302 is configured to send the AI model to a radio access network device; and the radio access network is a node that performs inference using the AI model.

In one implementation, the receiving unit 301 receives the AI model in the following manner: receiving the AI model based on a second transmission protocol between the server and the terminal.

In one implementation, the receiving unit 301 receives the AI model based on the second transmission protocol between the server and the terminal in the following manner: receiving the AI model encapsulated and sent by the server based on the second transmission protocol; and the receiving unit is further configured to: parse the encapsulated AI model based on the second transmission protocol.

In one implementation, the sending unit 302 sends the AI model to the radio access network device in the following manner: sending the AI model to the radio access network device based on a third transmission protocol between the terminal and the radio access network device.

In one implementation, the sending unit 302 sends the AI model to the radio access network device based on the third transmission protocol between the terminal and the radio access network device in the following manner: encapsulating the AI model and sending it to the radio access network device based on the third transmission protocol.

In one implementation, the sending unit 302 sends the AI model to the radio access network device in the following manner: sending the AI model to a core network device based on a fourth transmission protocol between the terminal and the core network device; where the AI model is sent by the core network device to the radio access network device based on a fifth transmission protocol between the core network device and the radio access network device.

In one implementation, the sending unit 302 sends the AI model to the core network device based on the fourth transmission protocol between the terminal and the core network device in the following manner: encapsulating the AI model and sending it to the core network device based on the fourth transmission protocol.

In one implementation, the fourth transmission protocol includes a non-access stratum (NAS) signaling protocol or a UP protocol.

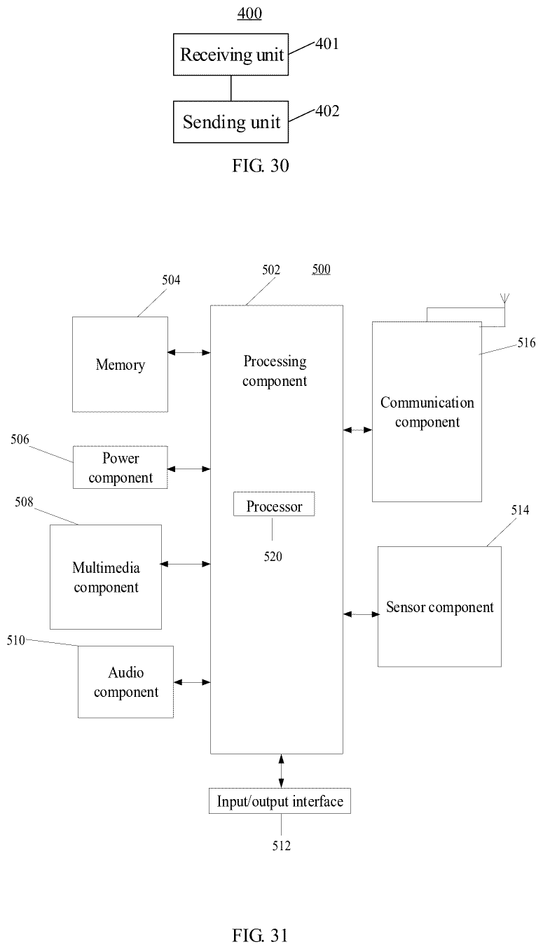

FIG. 30 is a block diagram of a communication apparatus shown according to an exemplary embodiment. Referring to FIG. 30, the apparatus 400 includes a receiving unit 401 and a sending unit 402.

The receiving unit 401 is used to receive an AI model, where the AI model is sent by a server, and the server is a provider node of the AI model. The sending unit 402 is used to send the AI model to a radio access network device; and the radio access network is a node that performs inference using the AI model.

In one implementation, the receiving unit 401 receives the AI model in the following manner: receiving the AI model sent by the terminal based on a fourth transmission protocol between the terminal and the core network device; where the AI model is sent to the terminal by the server based on a second transmission protocol between the server and the terminal.

In one implementation, the sending unit 402 sends the AI model to the radio access network device in the following manner: sending the AI model to the radio access network device based on a fifth transmission protocol between the core network device and the radio access network device.

In one implementation, the sending unit 402 sends the AI model to the radio access network device based on the fifth transmission protocol between the core network device and the radio access network device in the following manner: encapsulating the AI model and sending it to the radio access network device based on the fifth transmission protocol.

In one implementation, the fifth transmission protocol includes a transmission protocol between an AMF and the radio access network device, or the third transmission protocol includes a transmission protocol between a UPF and the radio access network device.

Regarding the apparatus in the above embodiment, the specific manner in which each module performs operations has been described in detail in the embodiment of the method, and will not be elaborated here.

The technical solutions provided by the embodiments of the present disclosure may include the following beneficial effects: for a scenario where the AI provider node is located on a server and the AI inference node is located on the radio access network device, the server can send an AI model to the radio access network device so that the radio access network device receives the AI model. Thus, the radio access network device can subsequently perform inference tasks through the received AI model.

FIG. 31 is a block diagram of a communication apparatus 500 according to an exemplary embodiment. For example, the apparatus 500 may be a mobile phone, a computer, a digital broadcast terminal, a messaging device, a game console, a tablet device, a medical device, a fitness device, a personal digital assistant, etc.

Referring to FIG. 31, the apparatus 500 may include one or more of the following components: a processing component 502, a memory 504, a power component 506, a multimedia component 508, an audio component 510, an input/output (I/O) interface 512, a sensor component 514, and a communication component 516.

The processing component 502 generally controls the overall operation of the apparatus 500, such as operations associated with display, phone calls, data communications, camera operations, and recording operations. The processing component 502 may include one or more processors 520 to execute instructions to perform all or part of the steps of the above method. In addition, the processing component 502 may include one or more modules to facilitate the interaction between the processing component 502 and other components. For example, the processing component 502 may include a multimedia module to facilitate the interaction between the multimedia component 508 and the processing component 502.

The memory 504 is configured to store various types of data to support the operations at the apparatus 500. Examples of these data include instructions for any application or method operated on the apparatus 500, contact data, phone book data, messages, pictures, videos, etc. The memory 504 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 506 provides power for various components of the apparatus 500. The power component 506 may include a power management system, one or more power supplies, and other components associated with power generation, management and distribution of the apparatus 500.

The multimedia component 508 includes a screen that provides an output interface between the apparatus 500 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may not only sense the boundary of a touch or slide, but also detect the duration and pressure associated with the touch or slide operation. In some embodiments, the multimedia component 508 includes a front camera and/or a rear camera. When the apparatus 500 is in an operating mode, such as a shooting mode or a video mode, the front camera and/or the rear camera may receive external multimedia data. Each front camera and rear camera may be a fixed optical lens system or have a focal length and optical zoom capability.

The audio component 510 is configured to output and/or input an audio signal. For example, the audio component 510 includes a microphone (MIC), and when the apparatus 500 is in an operation mode, such as a call mode, a recording mode, and a voice recognition mode, the microphone is configured to receive an external audio signal. The received audio signal may be further stored in the memory 504 or sent via the communication component 516. In some embodiments, the audio component 510 further includes a speaker for outputting audio signals.

I/O interface 512 provides an interface between the processing component 502 and the peripheral interface module. The peripheral interface module may be a keyboard, a click wheel, buttons, etc. These buttons may include, but are not limited to a home button, a volume button, a start button, and a lock button.

The sensor assembly 514 includes one or more sensors for providing various aspects of the state assessment for the apparatus 500. For example, the sensor assembly 514 may detect an on/off state of the apparatus 500, and relative positions of components, such as a display and a keypad of the apparatus 500. The sensor assembly 514 may also detect a position change of the apparatus 500 or a component of the apparatus 500, the presence or absence of contact between the user and the apparatus 500, an orientation or acceleration/deceleration of the apparatus 500, and a temperature change of the apparatus 500. The sensor assembly 514 may include a proximity sensor configured to detect the presence of a nearby object without any physical contact. The sensor assembly 514 may also include an optical sensor, such as a CMOS or CCD image sensor, for use in imaging applications. In some embodiments, the sensor assembly 514 may further include an acceleration sensor, a gyroscope sensor, a magnetic sensor, a pressure sensor, or a temperature sensor.

The communication component 516 is configured to facilitate wired or wireless communication between the apparatus 500 and other devices. The apparatus 500 can access a wireless network based on a communication standard, such as WiFi, 2G or 3G, or a combination thereof. In an exemplary embodiment, the communication component 516 receives a broadcast signal or broadcast association information from an external broadcast management system via a broadcast channel. In an exemplary embodiment, the communication component 516 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology and other technologies.

In an exemplary embodiment, the apparatus 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In an exemplary embodiment, a non-transitory computer-readable storage medium including instructions is also provided, such as a memory 504 including instructions. The aforementioned instructions are executable by a processor 220 in the apparatus 200, for completing the above methods. For example, the non-transitory computer-readable storage medium may be a ROM, a random access memory (RAM), a CD-ROM, a magnetic tape, a floppy disc, an optical data storage device, and the like.

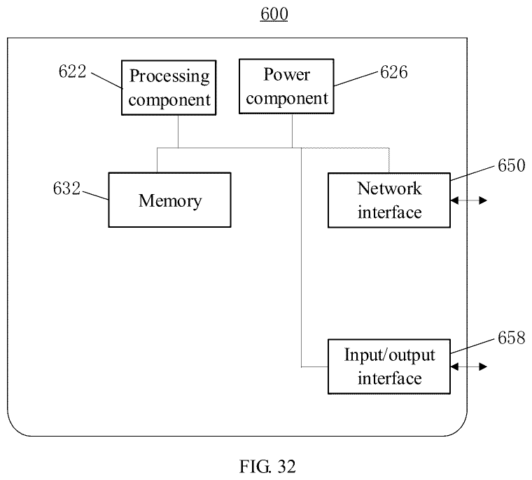

FIG. 32 is a block diagram of an apparatus for communication according to an exemplary embodiment. For example, the apparatus 600 may be provided as a server. Referring to FIG. 32, the apparatus 600 includes a processing component 622, which further includes one or more processors, and a memory resource represented by a memory 632 for storing instructions executable by the processing component 622, such as an application program. The application program stored in the memory 632 may include one or more modules, each corresponding to a set of instructions. In addition, the processing component 622 is configured to execute instructions to perform the above-mentioned communication methods.

The apparatus 600 may further include a power component 626 configured to perform power management of the apparatus 600, a wired or wireless network interface 650 configured to connect the apparatus 600 to the network, and an input/output (I/O) interface 658. The apparatus 600 may operate based on an operating system stored in the memory 632, such as Windows ServerTM, Mac OS X TM, UnixTM, LinuxTM, FreeBSDTM, or the like.

In an exemplary embodiment, there is also provided a non-transitory computer-readable storage medium including instructions, such as included in a memory 632, executable by the processing component 622 of the apparatus 600, for completing the above methods. For example, the non-transitory computer-readable storage medium may be a ROM, a random access memory (RAM), a CD-ROM, a magnetic tape, a floppy disk, an optical data storage device, and the like.

It may be further understood that, in the present disclosure, “a plurality of” means two or more than two, and other quantifiers are similar thereto. “And/or” describes the association relationship of associated objects, which indicates that three relationships may exist. For example, A and/or B may represent: A exists alone, A and B exist at the same time, and B exists alone. The character “/” generally indicates that the associated objects before and after are in an “or” relationship. The singular forms of “a”, “the” and “said” are also intended to include the plural forms, unless otherwise clearly indicated by the context.

It is further understood that the meanings of the terms such as “in response to”, “if” or “upon” involved in the present disclosure depend on the context and the actual usage scenario. For example, the term “in response to” used herein can be interpreted as “at the time of” or “when . . . ” or “if”.

It is further understood that the terms “first”, “second”, etc. are used to describe a variety of information, but the variety of information should not be limited to these terms. These terms are used only to distinguish information of the same type from one another and do not indicate a particular order or level of importance. In fact, the expressions “first” and “second” can be used interchangeably. For example, without departing from the scope of the present disclosure, the first information may also be referred to as the second information, and similarly, the second information may also be referred to as the first information.

It is further understood that although the operations are depicted in the accompanying drawings in a particular order in embodiments of the present disclosure, this should not be construed as requiring that the operations be performed in the particular order shown or in serial order, or that all of the operations shown be performed to obtain the desired results. Multitasking and parallel processing may be advantageous in particular environments.

Those skilled in the art will readily appreciate other embodiments of the present disclosure after considering the specification and practicing the invention disclosed herein. The present application is intended to cover any modifications, uses or adaptations of the present disclosure, which follow the general principles of the present disclosure and include common knowledge or customary technical means in the art that are not disclosed in the present disclosure.

It should be understood that the present disclosure is not limited to the exact construction that has been described above and illustrated in the accompanying drawings, and that various modifications and changes can be made without departing from the scope thereof. The scope of the present disclosure is only limited by the appended claims.

1. A communication method, applied to a server, wherein the server is a provider node of an artificial intelligence (AI) model, and the method comprises:
sending the AI model to a radio access network device;
wherein the radio access network device is a node that performs inference using the AI model.

2. The method according to claim 1, wherein sending the AI model to the radio access network device comprises one of following:
sending the AI model to the radio access network device based on a first transmission protocol between the server and a radio access network;
sending the AI model to a terminal based on a second transmission protocol between the server and the terminal, wherein the AI model is sent by the terminal to the radio access network device based on a third transmission protocol between the terminal and the radio access network device; or
sending the AI model to a core network device based on a sixth transmission protocol between the server and the core network device, wherein the AI model is sent by the core network device to the radio access network device based on a seventh transmission protocol between the core network device and the radio access network device.

3. (canceled)

4. The method according to claim 23, wherein sending the AI model to the terminal based on the second transmission protocol between the server and the terminal comprises:
encapsulating the AI model and sending the AI model to the terminal based on the second transmission protocol.

5. The method according to claim 4, wherein the AI model being sent by the terminal to the radio access network device, comprises:
the AI model being sent by the terminal to thea core network device based on a fourth transmission protocol between the terminal and the core network device;
wherein the AI model is sent by the core network device to the radio access network device based on a fifth transmission protocol between the core network device and the radio access network device.

6. The method according to claim 5, wherein the AI model being sent by the terminal to the core network device based on the fourth transmission protocol between the terminal and the core network device, comprises:
the AI model being encapsulated and sent to the core network device by the terminal based on the fourth transmission protocol.

7. (canceled)

8. The method according to claim 2, wherein sending the AI model to the core network device based on the sixth transmission protocol between the server and the core network device comprises:
encapsulating the AI model and sending the AI model to the core network device based on the sixth transmission protocol.

9. A communication method, applied to a radio access network device, wherein the radio access network device is a node for performing inference by using an AI model, and the method comprises:
receiving the AI model sent by a server;
wherein the server is a provider node of the AI model.

10. The method according to claim 9, wherein receiving the AI model sent by the server comprises one of following:
receiving the AI model sent by the server based on a first transmission protocol between the server and a radio access network;
receiving the AI model sent by a terminal based on a third transmission protocol between the radio access network device and the terminal, wherein the AI model is sent by the server to the terminal based on a second transmission protocol between the server and the terminal;
receiving the AI model sent by a core network device based on a fifth transmission protocol between the core network device and the radio access network device, wherein the AI model is sent by the terminal to the core network device based on a fourth transmission protocol between the terminal and the core network device, and the AI model is sent by the server to the terminal based on the second transmission protocol between the server and the terminal; or
receiving the AI model sent by the core network device based on a seventh transmission protocol between the core network device and the radio access network device, wherein the AI model is sent by the server to the core network device based on a sixth transmission protocol between the server and the core network device.

11.-13. (cancelled)

14. The method according to claim 10 , wherein the received AI model comprises an AI model encapsulated and sent based on a transmission protocol, and the transmission protocol comprises the first transmission protocol, the third transmission protocol, the fifth transmission protocol, or the seventh transmission protocol; and
the method further comprises:
parsing the encapsulated AI model based on the transmission protocol used for receiving the AI model.

15. A communication method, applied to a terminal, the method comprising:
receiving an AI model sent by a server, wherein the server is a provider node of the AI model; and
sending the AI model to a radio access network device;
wherein the radio access network is a node that performs inference using the AI model.

16. The method according to claim 15, wherein receiving the Al model comprises:
receiving the AI model based on a second transmission protocol between the server and the terminal.

17. The method according to claim 16, wherein receiving the Al model based on the second transmission protocol between the server and the terminal comprises:
receiving the AI model encapsulated and sent by the server based on the second transmission protocol;
the method further comprising:
parsing the encapsulated AI model based on the second transmission protocol.

18. The method according to claim 15, wherein sending the AI model to the radio access network device comprises one of following:
sending the AI model to the radio access network device based on a third transmission protocol between the terminal and the radio access network device; or
sending the AI model to a core network device based on a fourth transmission protocol between the terminal and the core network device, wherein the AI model is sent by the core network device to the radio access network device based on a fifth transmission protocol between the core network device and the radio access network device.

19. The method according to claim 18, wherein sending the AI model to the radio access network device a core network device based on the third transmission protocol between the terminal and the radio access network device comprises:
encapsulating the AI model and sending the AI model to the radio access network device based on the third transmission protocol.

20. (canceled)

21. The method according to claim 18, wherein sending the AI model to the core network device based on the fourth transmission protocol between the terminal and the core network device comprises:
encapsulating the AI model and sending the AI model to the core network device based on the fourth transmission protocol.

22. The method according to claim 18, wherein the fourth transmission protocol comprises a non-access layer (NAS) signaling protocol or a UP protocol.

23.-32. (canceled)

33. A communication apparatus, comprising:
a processor; and
a memory for storing processor-executable instructions;
wherein the processor is configured to perform the method according to claim 1.

34. A communication apparatus, comprising:
a processor; and
a memory for storing processor-executable instructions;
wherein the processor is configured to perform the method according to claim 9.

35. A communication apparatus, comprising:
a processor; and
a memory for storing processor-executable instructions;
wherein the processor is configured to perform the method according to claim 15.

36.-38. (canceled)

39. A non-transitory storage medium, wherein instructions are stored in the non-transitory storage medium, and the instructions in the non-transitory storage medium, when executed by a processor, cause the processor to execute the communication method according to claim 15.

40. (canceled)
